(19) United States
(12) Patent Application Publication
(10) Pub. No.: US 2013/0246610 A1
(43) Pub. Date: Sep. 19, 2013

(54) INFORMATION PROCESSING APPARATUS, INFORMATION PROCESSING SYSTEM, INFORMATION PROCESSING METHOD, AND NON-TRANSITORY COMPUTER-READABLE MEDIUM

(71) Applicant: Yasuhiro HIRANO, Kanagawa (JP)

(72) Inventor: Yasuhiro HIRANO, Kanagawa (JP)

(73) Assignee: FUJI XEROX CO., LTD., Tokyo (JP)

(21) Appl. No.: 13/559,219

(22) Filed: Jul. 26, 2012

(30) Foreign Application Priority Data
Mar. 14, 2012 (JP) 2012-057863

(51) Int. Cl. G06F 15/173

(52) U.S. Cl. 709/224

(57) ABSTRACT

An information processing apparatus includes a detector, a first determination unit, an identification unit, a second determination unit, and a transmitting unit. The detector detects an event which has occurred in the information processing apparatus. The first determination unit determines whether or not a type of event into which the event is classified is included in types of events determined in advance. The identification unit identifies data which is a target for the event. The second determination unit determines whether or not a type of data into which the data is classified is included in types of data determined in advance. The transmitting unit transmits, to another apparatus, information indicating a specific operator who is operating the information processing apparatus, information indicating a time at which the event occurred, the data or information used to refer to the data, and information indicating the details of the event.

### CROSS-REFERENCE TO RELATED APPLICATIONS

This application is based on and claims priority under 35 USC 119 from Japanese Patent Application No. 2012-057863 filed Mar. 14, 2012.

### BACKGROUND

### Technical Field

The present invention relates to an information processing apparatus, an information processing system, an information processing method, and a non-transitory computer-readable medium.

### SUMMARY

According to an aspect of the invention, there is provided an information processing apparatus including a detector, a first determination unit, an identification unit, a second determination unit, and a transmitting unit. The detector detects an event which has occurred in the information processing apparatus. The first determination unit determines whether or not a type of event into which the event detected by the detector is classified is included in multiple types of events which are determined in advance. The identification unit identifies data which is a target for the event detected by the detector. The second determination unit determines whether or not a type of data into which the data identified by the identification unit is classified is included in multiple types of data that are determined in advance. Under a condition where it is determined by the first determination unit that the type of event is included in the multiple types of events and it is determined by the second determination unit that the type of data is included in the multiple types of data, the transmitting unit transmits, to another apparatus, an information item indicating a specific operator who is operating the information processing apparatus, an information item indicating a time at which the event occurred, the data or an information item used to refer to the data, and an information item indicating the details of the event.

### BRIEF DESCRIPTION OF THE DRAWINGS

An exemplary embodiment of the present invention will be described in detail based on the following figures, wherein:

FIG. 1 is a diagram illustrating an example of a configuration of a computer system according to an exemplary embodiment of the present invention;

FIG. 2 is a diagram illustrating an example of a hardware configuration of a client terminal in the exemplary embodiment of the present invention;

FIG. 3 is a diagram schematically illustrating an overview of the exemplary embodiment of the present invention;

FIG. 4 is a block diagram illustrating an example of a functional configuration of the client terminal in the exemplary embodiment of the present invention;

FIG. 5 is a block diagram illustrating an example of a functional configuration of a document server in the exemplary embodiment of the present invention;

FIG. 6 is a flowchart illustrating an example of an operation that is performed by the document server in the case where the document server transmits a document file in the exemplary embodiment of the present invention;

FIG. 7 is a flowchart illustrating an example of an operation that is performed by a log collection application which is operating in the client terminal in the exemplary embodiment of the present invention;

FIG. 8 is a flowchart illustrating an example of an operation that is performed by the document server in the case where the document server stores an event information item in the exemplary embodiment of the present invention; and

FIG. 9 is a diagram illustrating examples of information items stored in an event-information memory in the exemplary embodiment of the present invention.

### DETAILED DESCRIPTION

Hereinafter, exemplary embodiments of the present invention will be described in detail with reference to the accompanying drawings.

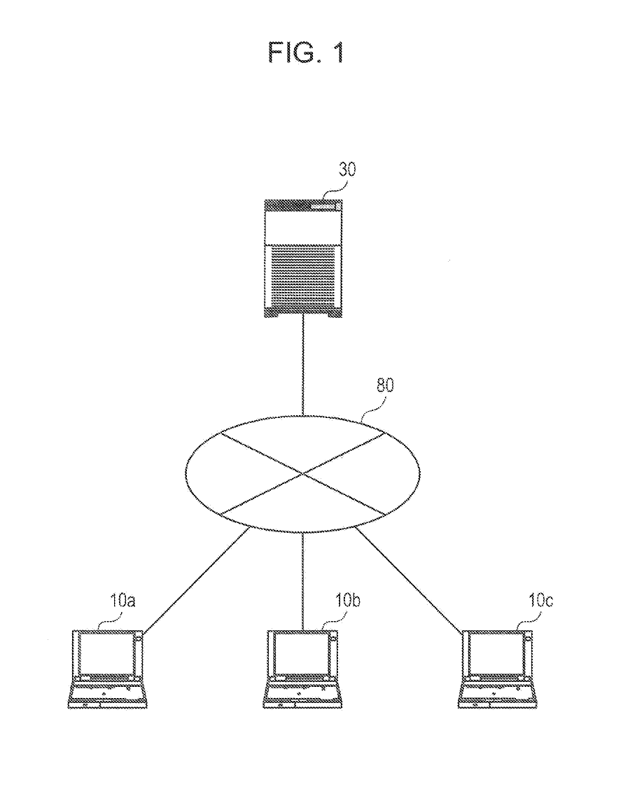

FIG. 1 illustrates an example of an entire configuration of a computer system according to a present exemplary embodiment.

As illustrated in FIG. 1, the computer system is configured by connecting client terminals 10a to 10c and a document server 30 to each other via a network 80.

Note that, although the client terminals 10a to 10c are illustrated in FIG. 1, when it is not necessary to distinguish the client terminals 10a to 10c from one another, the client terminals 10a to 10c are referred to as “client terminals 10”. Furthermore, although the only three client terminals 10 are illustrated in FIG. 1, four or more client terminals 10 may be provided.

Each of the client terminals 10 is a computer apparatus that is used by a user to view, edit, or the like a document file. More specifically, the client terminal 10 downloads a document file from the document server 30 in accordance with an operation performed by the user, allows the user to view, edit, or the like the document file, and uploads the document file to the document server 30. Here, a desktop personal computer (PC), a note PC, a tablet PC, a wearable computer, a personal digital assistant, a smartphone, a mobile phone, or the like may be used as the client terminal 10. In the present exemplary embodiment, the client terminal 10 is provided as an example of an operation apparatus.

The document server 30 is a computer apparatus that stores document files which are to be viewed, edited, or the like by a user. More specifically, the document server 30 stores, files that are generated using word processor software, spreadsheet software, presentation software, or the like, or files that can reproduce original images regardless of the environment, such as portable document format (PDF) files. However, in the present specification, the term “document file” does not necessarily refer only to a file that is obtained by converting a “document” including text into electronic form. For example, it is supposed that graphic data, such as graphics, and image data, such as pictures or photographs, are also included in the “document file”, regardless of whether or not the graphic data and the image data are vector data or raster data. Here, a PC or the like may be used as the document server 30. In the present exemplary embodiment, the document server 30 is provided as an example of an access apparatus.

The network 80 is a communication unit that is used for information communication between the client terminal 10 and the document server 30. The network 80 may be, for example, the Internet.

Next, a hardware configuration of the client terminal 10 will be described.

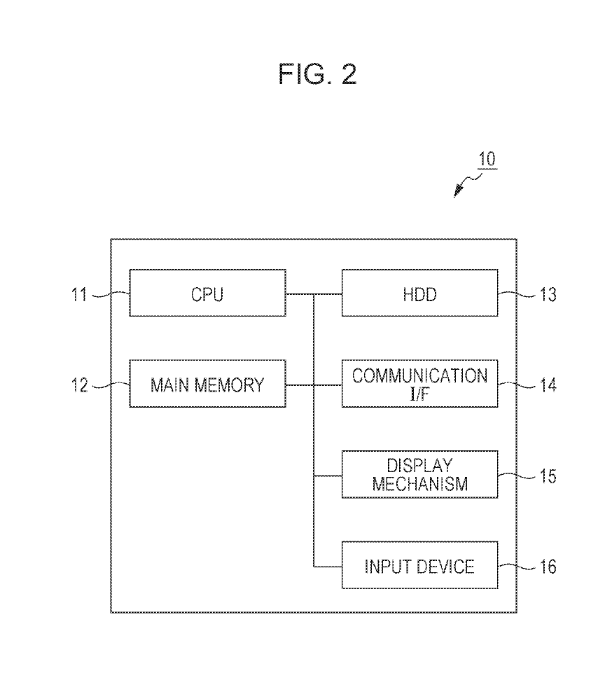

FIG. 2 is a diagram illustrating an example of the hardware configuration of the client terminal 10.

As illustrated in FIG. 2, the client terminal 10 includes a central processing unit (CPU) 11, which is a computation unit, and a main memory 12 or a hard disk drive (HDD) 13, which are memories. Here, the CPU 11 executes various types of software, such as an operating system (OS) and applications, to realize various types of functions described below. Furthermore, the main memory 12 is a storage region in which the various types of software, data used to execute the various types of software, and so forth are stored. The HDD 13 is a storage region in which input data that is to be input to the various types of software, output data that is output from the various types of software, and so forth are stored. Note that, in the case where the client terminal 10 is a smartphone or a mobile phone, a flash storage device may be used instead of the HDD 13.

Moreover, the client terminal 10 further includes a communication interface (I/F) 14 that is used to perform communication with external apparatuses, a display mechanism 15 that is constituted by a video memory, a display, and so forth, and an input device 16 such as a keyboard or a mouse.

Note that FIG. 2 may be considered as a diagram illustrating a hardware configuration of the document server 30. In this case, the CPU 11, the main memory 12, the HDD 13, the communication I/F 14, the display mechanism 15, and the input device 16 are replaced with a CPU 31, a main memory 32, an HDD 33, a communication I/F 34, a display mechanism 35, and an input device 36, respectively.

There is a case in which, in the computer system illustrated in FIG. 1, a document file stored in the document server 30 is downloaded to the individual client terminals 10, and in which users have, for example, a meeting, while utilizing the document file using various types of methods. In such a case, if the utilized document file can be reutilized later, it is useful and convenient to, for example, write up the minutes of the meeting. In addition to the case where a document file stored in the document server 30 is utilized, the same is also true for the case where a document file that is locally stored is utilized.

For this reason, in the present exemplary embodiment, document files that are utilized using a specific method in the client terminals 10 or link information items concerning links to the document files are transmitted to the document server 30. Later, the document files can be viewed and reutilized in a collective manner.

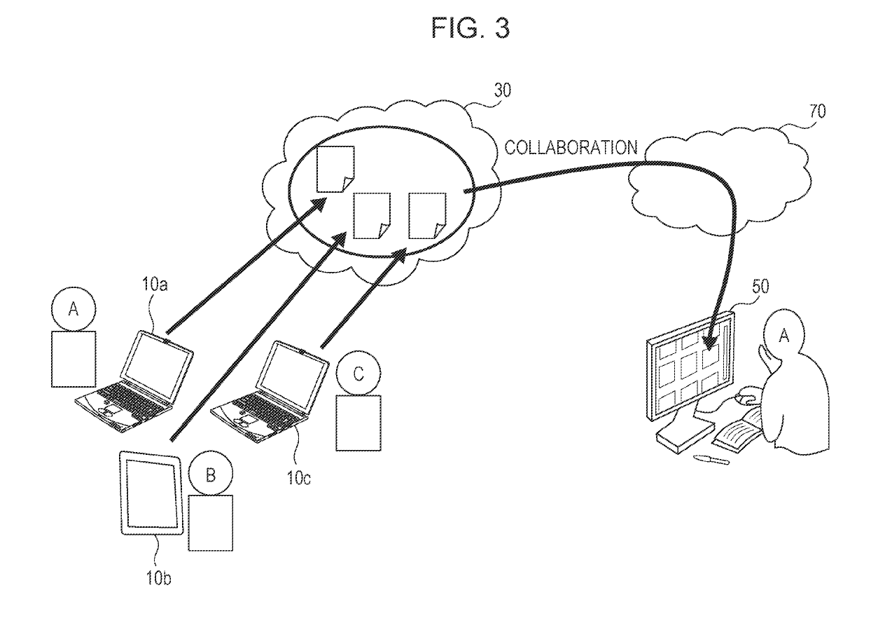

FIG. 3 is a diagram schematically illustrating an overview of the present exemplary embodiment. Here, a case is supposed, in which users A, B, and C have a regular meeting from 10 a.m. to 11 a.m. every Monday. More specifically, each of the users brings a note PC, a tablet PC, or the like into a meeting room, and conducts the meeting while sharing information items with the others by causing a projector to project his/her file or printing out the file during the meeting.

First, FIG. 3 illustrates a state in which the users A, B, and C have the meeting using the client terminals 10a, 10b, and 10c, respectively.

Here, it is supposed that a log collection application (hereinafter, referred to as a “log collection AP”) resides in each of the client terminals 10. In the log collection AP of each of the client terminals 10, it is supposed that a user identification (ID) of a user of the client terminal 10 is set as an identification information item (hereinafter, referred to as a “using user ID”) of a user (a using user) who uses a document file, and that user IDs of the users of the other client terminals 10 are set as identification information items (hereinafter, referred to as “permitted user IDs”) of users (permitted users) who have permission to access the document file used by the using user. Furthermore, in the log collection AP of each of the client terminals 10, it is supposed that a time period “from 10:00 to 11:00 every Monday”, “PDF” and “PPT”, and “printing” and “full-screen output to an external monitor” are set as a specified time period, specified file types, and specified event types, respectively, so as to be common settings.

In the case where the users A, B, and C, for example, perform printing or full-screen output to an external monitor during the time period from 10 a.m. to 11 a.m. on Monday, for document files in PDF or PPT format that are targets for printing or full-screen output to an external monitor, the log collection AP uploads, to the document server 30, copies of the document files or link information items concerning links to the document files, together with attribute information items.

Moreover, in FIG. 3, a state in which the copies of the document files or the link information items concerning links to the document files, which have been uploaded to the document server 30, are utilized is also illustrated.

For example, after the meeting, the user A logs in to schedule service 70 (not illustrated in FIG. 1) on a web from a client terminal 50 (not illustrated in FIG. 1) that is a desktop PC or the like different from the client terminal 10a that the user A brought into the meeting. Then, when the user A opens the schedule of the meeting that was held, the document files used in the meeting, i.e., the document files that were printed or output to an external monitor, are displayed as a list, and the document files used by the other users are also included in the list. The user A opens a necessary document file among the document files included in the list, writes up the minutes of the meeting while recalling the meeting, and shares the document file with the users B and C.

Note that, although the schedule server 70 is described as external service of the document server 30 in the present specification, the schedule server 70 may be described as service that the document server 30 provides.

Additionally, the document server 30 may achieve synchronization among client terminals 10 that are specified in advance for the above-mentioned settings which are set in the log collection AP.

Next, a configuration of each of the apparatuses in the present exemplary embodiment will be described.

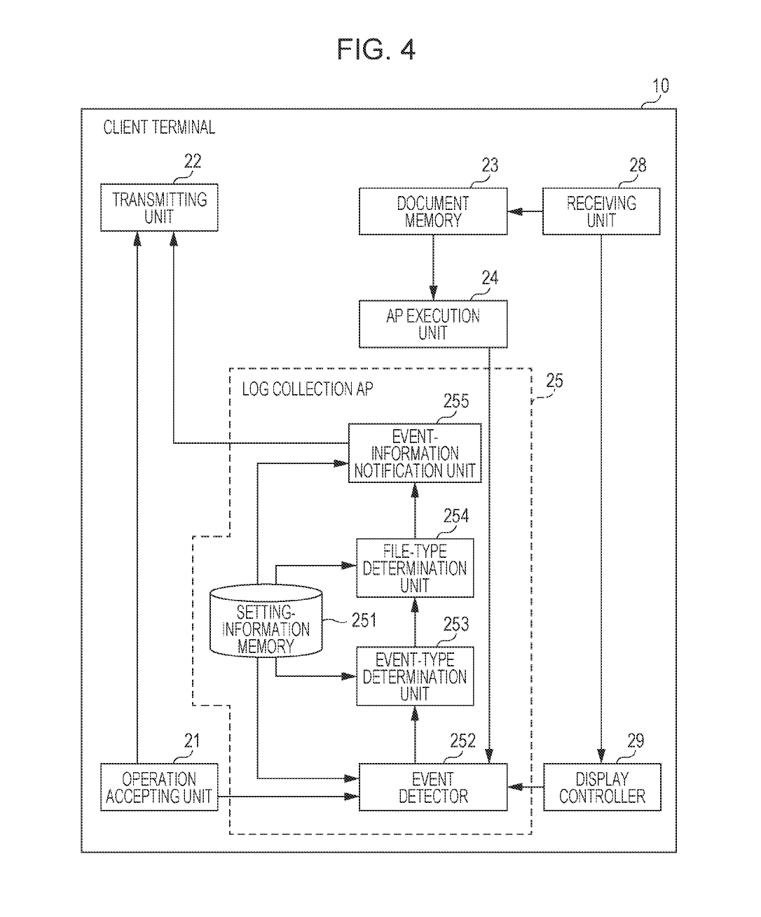

FIG. 4 is a block diagram illustrating an example of a functional configuration of the client terminal 10.

As illustrated in FIG. 4, the client terminal 10 includes an operation accepting unit 21, a transmitting unit 22, a document memory 23, an application execution unit (hereinafter, referred to as an “AP execution unit”) 24, a receiving unit 28, and a display controller 29. Moreover, a log collection AP 25 resides in the client terminal 10. The log collection AP 25 includes a setting-information memory 251, an event detector 252, an event-type determination unit 253, a file-type determination unit 254, and an event-information notification unit 255.

The operation accepting unit 21 accepts, for example, an operation in which a user logs in to the document server 30 or an operation in which a user selects a document file that is desired to be viewed, edited, or the like.

When the operation accepting unit 21 has accepted the operation in which a user logs in to the document server 30, the transmitting unit 22 transmits, to the document server 30, an identification information item (hereinafter, referred to as a “user ID”) of the user. When the operation accepting unit 21 has accepted the operation in which a user selects a document file, the transmitting unit 22 transmits, to the document server 30, an identification information item (hereinafter, referred to as a “document ID”) of the document. When the transmitting unit 22 is notified of a using user ID, a permitted user ID, and an event information item from the log collection AP 25, the transmitting unit 22 transmits the using user ID, the permitted user ID, and the event information item to the document server 30. Here, an information item indicating a memory location which is a location in the document server 30 and at which a document file is stored may be used as the document ID of the document file. The information item indicating a memory location is, for example, a uniform resource identifier (URL).

The document memory 23 stores a document file that has been transmitted from the document server 30 at the memory location indicated by the document ID of the document file.

The AP execution unit 24 executes an application (an application program) that has been installed in the client terminal 10. Here, examples of the application include an application that processes a document file stored in the document memory 23. In the case where the application processes a document file, because the application recognizes a memory location which is a location in the document memory 23 and at which the document file is stored, the application can recognize the document ID indicating the memory location.

When the transmitting unit 22 has transmitted a user ID, the receiving unit 28 receives, from the document server 30, a list of document IDs of document files that the user can view, edit, or the like. When the transmitting unit 22 has transmitted a document ID, the receiving unit 28 receives, from the document server 30, the document file stored at the memory location indicated by the document ID.

The display controller 29 performs control so that the list of the document IDs, the document file, or the like which have been received by the receiving unit 28 is displayed on the display mechanism 15.

Note that the functional units are realized through collaboration between a software resource and a hardware resource. More specifically, the CPU 11 loads, for example, from the HDD 13 into the main memory 12, a program that realizes the operation accepting unit 21, the transmitting unit 22, the AP execution unit 24, the receiving unit 28, and the display controller 29, and executes the program, whereby the functional units are realized. Moreover, the document memory 23 is realized, for example, by the HDD 13.

Next, the functional units included in the log collection AP 25 will be described.

The setting-information memory 251 stores a setting information item that includes, for example, a using user ID, a permitted user ID, a specified time period, specified file types, and specified event types.

The event detector 252 monitors the operation accepting unit 21, the AP execution unit 24, the display controller 29, and so forth, thereby detecting an event that has occurred in the client terminal 10 within the specified time period included in the setting information item stored in the setting-information memory 251. Here, examples of the event include an event (hereinafter, referred to as an “AP event”) that occurs in an application executed by the AP execution unit 24, and an event (hereinafter, referred to as an “other-than-AP event”) that occurs in a software or hardware resource (an OS, hardware, or the like) other than any application executed by the AP execution unit 24. Examples of the AP event include “opening of a file” and “printing”, and the AP event is detected by monitoring the AP execution unit 24. In contrast, examples of the other-than-AP event include “full-screen output to an external monitor”, and the other-than-AP event is detected by monitoring the operation accepting unit 21, the display controller 29, and so forth. Note that, in the present specification, the term “external monitor” refers to not only a monitor of another computer, but also, for example, a screen onto which an image is projected by a projector. Additionally, the event detector 252 classifies the detected event into one of event types that are held in advance thereby, and transmits the event type to the event-type determination unit 253. In the present exemplary embodiment, the event detector 252 is provided as an example of a detecting unit that detects an event.

The event-type determination unit 253 determines whether or not the event type, which has been transmitted from the event detector 252, is included in the specified event types included in the setting information item stored in the setting-information memory 251. In the present exemplary embodiment, the event-type determination unit 253 is provided as an example of a first determination unit that determines whether or not a detected event is included in multiple types of events which are determined in advance.

When the event type is included in the specified event types, the file-type determination unit 254 identifies the document ID of a document file that is a target for the event. The file-type determination unit 254 identifies, on the bass of the document ID, the file type into which the document file is classified, and determines whether or not the file type is included in the specified file types included in the setting information item stored in the setting-information memory 251. Here, the document ID of a document file that is a target for the event may be identified as follows. In other words, when the event detected by the event detector 252 is an AP event, for example, the document ID is identified on the basis of an information item that has been output from an application in which the event has occurred. In contrast, when the event detected by the event detector 252 is an other-than-AP event, the document ID is identified using a method that is suitable for the event type. More particularly, in the case where the event is “full-screen output to an external monitor” among other-than-AP events, for example, when the event has occurred, an application that displays the frontmost window is identified, and the document ID is identified on the basis of the relationships, which are held by the application, between document IDs and display layers. Moreover, the file type may be identified on the basis of a filename extension included in the document ID. In the present exemplary embodiment, the file-type determination unit 254 is provided as an example of an identification unit that identifies data which is a target for an event and a second determination unit that determines whether or not the type of data into which the identified data is classified is included in multiple types of data that are determined in advance.

When the file type into which the document file that is a target for the event is classified is included in the specified file types, the event-information notification unit 255 notifies the transmitting unit 22 of a using user ID, a permitted user ID, and an event information item, and instructs the transmitting unit 22 to transmit the using user ID, the permitted user ID, and the event information item to the document server 30. Here, the using user ID and the permitted user ID have been obtained from the setting information item stored in the setting-information memory 251. Additionally, the event information item includes an event occurrence time at which the event occurred and which has been obtained using the machine time of the client terminal 10, the document ID that has been identified by the file-type determination unit 254, and the event type that has been identified by the event detector 252. In the present exemplary embodiment, the event-information notification unit 255 is provided as an example of a transmitting unit that transmits information items. Furthermore, the using user ID is used as an example of an operator information item. The event information item is used as an example of an event information item. The event-information notification unit 255 is provided as an example of the transmitting unit that transmits the operator information item and the event information item. Moreover, the permitted user ID is used as an example of a permitted-person information item. The event-information notification unit 255 is provided as an example of the transmitting unit that transmits the permitted-person information item and the event information item.

Note that the functional units included in the log collection AP 25 are realized through collaboration between a software resource and a hardware resource. More specifically, the CPU 11 loads the log collection AP 25, for example, from the HDD 13 into the main memory 12, and executes the log collection AP 25, whereby the functional units are realized. Moreover, the setting-information memory 251 is realized by, for example, a region that is a region in the HDD 13 and that is assigned to the log collection AP 25.

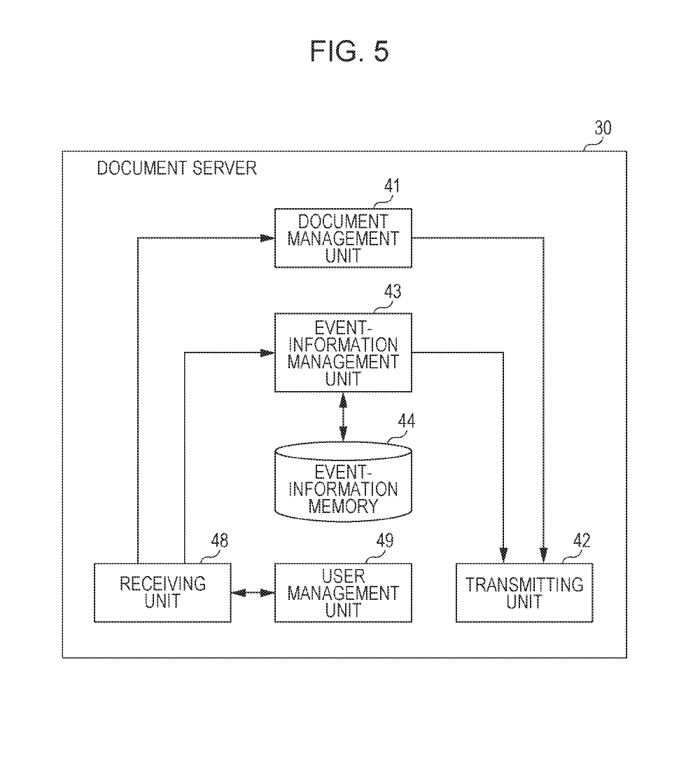

FIG. 5 is a block diagram illustrating an example of a functional configuration of the document server 30.

As illustrated in FIG. 5, the document server 30 includes a document management unit 41, a transmitting unit 42, an event-information management unit 43, an event-information memory 44, a receiving unit 48, and a user management unit 49.

The document management unit 41 manages document files at memory locations that are locations in a document memory which is not illustrated and that are indicated, for example, by document IDs. In other words, the document management unit 41 obtains a document file from the document memory, or stores a document file in the document memory. Furthermore, the document management unit 41 also manages document files that are associated with users who can view, edit, or the like the document files. For example, user IDs and document IDs are associated with each other. Accordingly, the document management unit 41 obtains the document ID of a document file that a certain user can view, edit, or the like.

When the document management unit 41 has obtained a list of the document IDs of document files that a user can view, edit, or the like, the transmitting unit 42 transmits the list of the document IDs to the client terminal 10. When the document management unit 41 has obtained a document file, the transmitting unit 42 transmits the document file to the client terminal 10.

The event-information management unit 43 manages, in the event-information memory 44, an event information item that has been transmitted from the client terminal 10, so that the event information item is associated with the schedule of a using user and the schedule of a permitted user which are managed by the schedule server 70 (see FIG. 3). In other words, the event-information management unit 43 identifies, among schedule information items that indicate the schedules of individual users and that are managed by the schedule server 70 so as to be associated with the user IDs of the users, a schedule information item that is managed so as to be associated with the using user ID and a schedule information item that is managed so as to be associated with the permitted user ID. The event-information management unit 43 stores an event information item at a memory location that is a location in the event-information memory 44 and that is linked to from the individual schedule information items, or obtains an event information item from a memory location that is a location in the event-information memory 44 and that is linked to from the individual schedule information items. In the present exemplary embodiment, the schedule information items are used as examples of an action-plan information item. The event-information management unit 43 is provided as an example of a selection unit that selects the action-plan information item.

The event-information memory 44 stores, under management performed by the event-information management unit 43, an event information item so that the event information item is associated with a schedule information item. In the present exemplary embodiment, the event-information memory 44 is provided as an example of a storage unit that stores the event information item.

When a user has performed the operation of logging in to the document server 30, the receiving unit 48 receives the user ID of the user from the client terminal 10. When a user has performed the operation of selecting a document file, the receiving unit 48 receives the document ID of the document file from the client terminal 10. When the log collection AP 25 has detected an event that the log collection AP 25 should notify the document server 30 of, the receiving unit 48 receives a using user ID, a permitted user ID, and an event information item from the client terminal 10. In the present exemplary embodiment, the receiving unit 48 is provided as an example of a receiving unit that receives the operator information item and the event information item and the receiving unit that receives the operator information item, the permitted-person information item, and the event information item.

The user management unit 49 manages user IDs that the receiving unit 48 has received. In other words, in the case where a user logs in to the document server 30, the receiving unit 48 receives a password in addition to the user ID of the user. Accordingly, the user management unit 49 checks whether or not the combination of the user ID and the password exists among combinations that are combinations of a user ID and a password and that are registered in advance, thereby performing authentication of the user. When the authentication has succeeded, the user management unit 49 generates a session ID, and associates the user ID with the session ID. After that, when the receiving unit 48 has received an information item in a state in which the user continues logging in to the document server 30, because the session ID is included in the information item, the user management unit 49 returns, to the receiving unit 48, the user ID that is associated with the session ID.

Note that the functional units are realized through collaboration between a software resource and a hardware resource. More specifically, the CPU 31 loads, for example, from the HDD 33 into the main memory 32, a program that realizes the document management unit 41, the transmitting unit 42, the event-information management unit 43, the receiving unit 48, and the user management unit 49, and executes the program, whereby the functional units are realized. Moreover, the event-information memory 44 is realized, for example, by the HDD 33.

Next, operations in the present exemplary embodiment will be described.

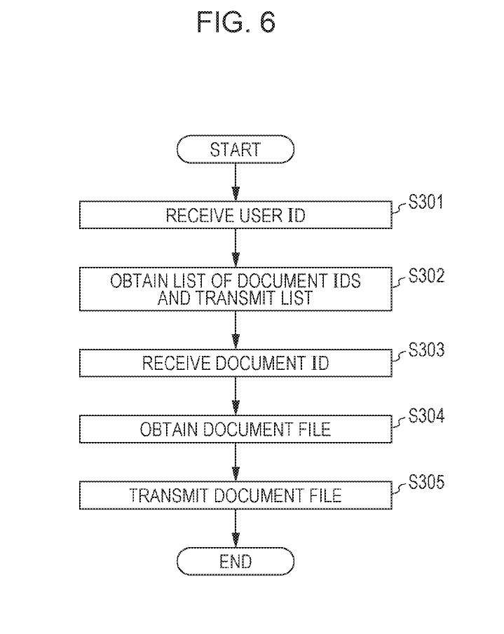

FIG. 6 is a flowchart illustrating an example of an operation that is performed by the document server 30 in the case where the document server 30 transmits a document file. In the client terminal 10, the operation accepting unit 21 accepts the operation of logging in to the document server 30, and the transmitting unit 22 transmits a user ID to the document server 30, whereby the operation illustrated in the flowchart starts.

When the operation starts, in the document server 30, first, the receiving unit 48 receives the user ID (step S301). Note that the user ID is managed by the user management unit 49, and, after this, an access made from the same user in a state in which the user continues logging in to the document server 30 can be recognized.

Furthermore, the receiving unit 48 transmits the user ID to the document management unit 41. Accordingly, the document management unit 41 obtains a list of the document IDs of document files associated with the user ID, and the transmitting unit 42 transmits the list of the document IDs to the client terminal 10 (step S302). Thus, in the client terminal 10, the receiving unit 28 receives the list of the document IDs, and the display controller 29 performs control so that the list of the document IDs is displayed.

Next, in the client terminal 10, the operation accepting unit 21 accepts the operation of selecting the document ID of a document file that is desired to be viewed, edited, or the like from the list of the document IDs. The transmitting unit 22 transmits the selected document ID to the document server 30. Then, in the document server 30, the receiving unit 48 receives the document ID (step S303).

After that, the receiving unit 48 transmits the document ID to the document management unit 41. Accordingly, the document management unit 41 obtains the document file stored at a memory location indicated by the document ID (step S304).

Then, the transmitting unit 42 receives the document file from the document management unit 41, and transmits the document file to the client terminal 10 (step S305). Thus, in the client terminal 10, the receiving unit 28 receives the document file, and stores the document file in the document memory 23.

After at least one document file has been downloaded from the document server 30 in this manner, in the client terminal 10, the AP execution unit 24 executes at least one application that processes the at least one document file which has been downloaded. Then, the log collection AP 25 performs an operation of detecting an event and uploading an event information item to the document server 30.

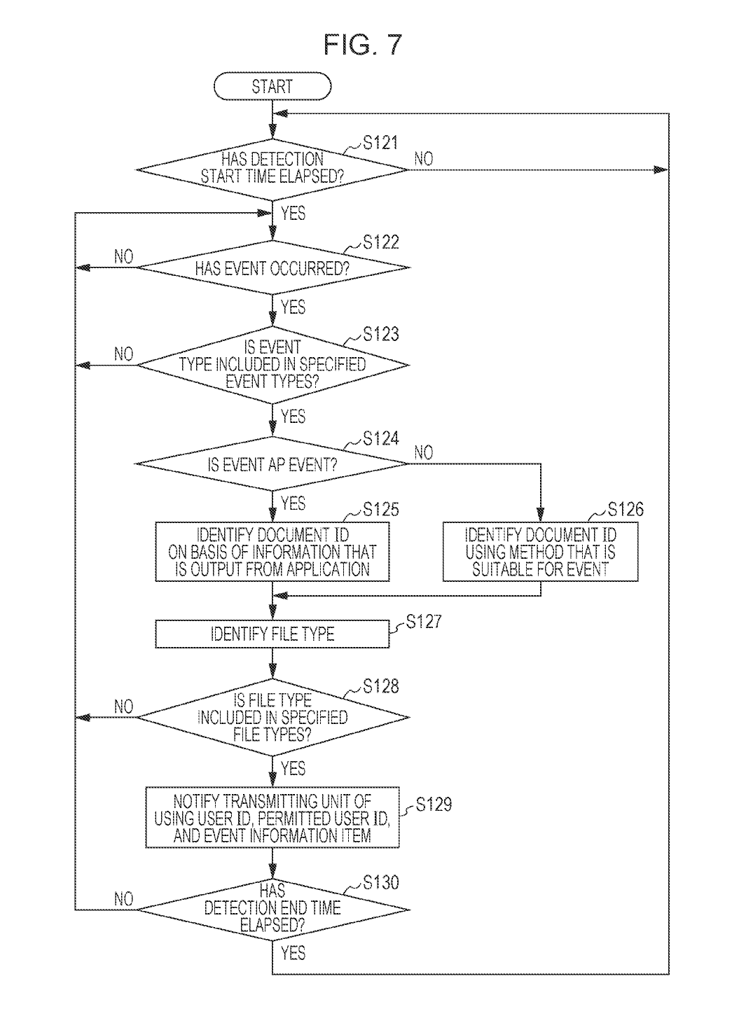

FIG. 7 is a flowchart illustrating an example of the operation performed by the log collection AP 25 in this case. Note that the log collection AP 25 resides in the client terminal 10 and is operating, and it is supposed that, when a stop instruction is provided from the outside to the log collection AP 25, the log collection AP 25 stops operating although stopping of the log collection AP 25 is not illustrated in the flowchart.

When the log collection AP 25 is activated, first, the event detector 252 determines whether or not a detection start time in the specified time period included in the setting information item stored in the setting-information memory 251 has elapsed (step S121).

When the event detector 252 determines that the detection start time has not elapsed, the event detector 252 repeats the process of step S121. In contrast, the event detector 252 determines that the detection start time has elapsed, the event detector 252 determines whether or not an event has occurred (step S122). More specifically, whether or not an AP event has occurred is determined by monitoring the AP execution unit 24. Furthermore, whether or not an other-than-AP event has occurred is determined by monitoring the operation accepting unit 21, the display controller 29, and so forth. More particularly, whether or not “full-screen output to an external monitor” has occurred is determined by monitoring whether or not the display controller 29 has recognized an external monitor or a device (a projector) that is used to output a screen to an external monitor and whether or not the operation accepting unit 21 has accepted an operation that is performed on the input device 16 in order to switch an output destination, to which the screen is to be output, to the external monitor.

When the event detector 252 determines that an event has not occurred, the event detector 252 repeats the process of step S122. In contrast, when the event detector 252 determines that an event has occurred, the event detector 252 identifies the event type into which the event is classified. The event detector 252 passes on the event type to the event-type determination unit 253, and transfers control to the event-type determination unit 253.

Then, the event-type determination unit 253 determines whether or not the event type that has been passed on is included in the specified event types included in the setting information item stored in the setting-information memory 251 (step S123).

When the event-type determination unit 253 determines that the event type which has been passed on is not included in the specified event types, the process returns to step S122. In contrast, when the event-type determination unit 253 determines that the event type which has been passed on is included in the specified event types, the event-type determination unit 253 passes on the event type to the file-type determination unit 254, and transfers control to the file-type determination unit 254.

Then, the file-type determination unit 254 determines, on the basis of the event type that has been passed on, whether or not the detected event is an AP event (step S124).

As a result, the file-type determination unit 254 determines that the detected event is an AP event, the file-type determination unit 254 identifies, on the basis of an information item that has been output from an application, the document ID of a document file that is a target for the event (step S125).

For example, in the case where the detected event is “printing”, the file-type determination unit 254 identifies, on the basis of an information item that has been output from an application to a print driver, the document ID of a document file that is a target for “printing”.

In contrast, when the file-type determination unit 254 determines that the detected event is not an AP event, i.e., that the detected event is an other-than-AP event, the file-type determination unit 254 identifies, using a method that is suitable for the event type, the document ID of a document file that is a target for the event (step S126).

For example, in the case where the detected event is “full-screen output to an external monitor”, the file-type determination unit 254 identifies the document ID using any one of the following methods.

A first method is a method using information items that an OS and an application hold. In this method, first, when the event has occurred, an application that displays the frontmost window is identified on the basis of a management information that concerns windows and that is held by the OS. Next, a document file that is displayed by the application in the frontmost window is indentified on the basis of the relationships, which are held by the application, between document files and display layers. The document ID of the document file is determined as the document ID that should be identified.

A second method is a method using the name of a document file displayed on a screen. In this method, first, when the event has occurred, a hard copy of a full screen is obtained, is subjected to image analysis, and is divided into images included in individual windows. Next, the name of a document file is extracted from the image included in the title bar of each of the windows, and a document ID corresponding to the name is determined as the document ID that should be identified.

A third method is a method using the contents of a document file displayed in a screen. Also in this method, first, as in the second method, when the event has occurred, a hard copy of a full screen is obtained, is subjected to image analysis, and is divided into images included in individual windows. Next, in the method, the image included in each of the windows is checked against the image of each document file stored in the document memory 23, and the document ID of a document file having an image that is the most similar to the image included in each of the windows is determined as the document ID that should be identified.

When the document ID has been identified in this manner, the file-type determination unit 254 identifies, on the basis of a filename extension included in the document ID, the file type into which the document file is classified that is a target for the detected event is classified (step S127). Then, the file-type determination unit 254 determines whether or not the file type into which the document file is classified is included in the specified file types included in the setting information item stored in the setting-information memory 251 (step S128).

When the file-type determination unit 254 determines that the identified file type is not included in the specified file types, the process returns to step S122. In contrast, when the file-type determination unit 254 determines that the identified file type is included in the specified file types, the file-type determination unit 254 passes on the event type, which has been identified in step S122, and the document ID, which has been identified in step S125 or S126, to the event-information notification unit 255, and transfers control to the event-information notification unit 255.

Then, the event-information notification unit 255 notifies the transmitting unit 22 of a using user ID, a permitted user ID, and an event information item (step S129). Here, the using user ID and the permitted user ID have been obtained from the setting information item stored in the setting-information memory 251. Furthermore, the event information item includes an event occurrence time at which the event occurred, and the document ID and the event type that have been passed on from the file-type determination unit 254. Thus, the transmitting unit 22 transmits the using user ID, the permitted user ID, and the event information item to the document server 30. Note that, here, when the transmitting unit 22 is notified of the using user ID, the permitted user ID, and the event information item from the event-information notification unit 255, the transmitting unit 22 transmits the using user ID, the permitted user ID, and the event information item to the document server 30 without any condition. However, a confirmation screen in which a user is asked for permission to transmit the using user ID, the permitted user ID, and the event information item may be displayed, and, when an instruction is provided from the user, the using user ID, the permitted user ID, and the event information item may be transmitted.

After that, control is transferred to the event detector 252. The event detector 252 determines whether or not a detection end time in the specified time period included in the setting information item stored in the setting-information memory 251 has elapsed (step S130).

When the event detector 252 determines that the detection end time has not elapsed, the process returns to step S122. In contrast, when the event detector 252 determines that the detection end time has elapsed, the process returns to step S121.

Note that, in the example of the operation, when the client terminal 10 detects an event, an event information item including the document ID of a document file is transmitted to the document server 30. However, the event information item may include the document file or a copy of the document file, and may be transmitted to the document server 30.

When a using user ID, a permitted user ID, and an event information item have been transmitted from the client terminal 10 in this manner, the document server 30 performs an operation of storing the event information item so that the event information item is associated with a schedule information item associated with the using user ID and a schedule information item associated with the permitted user ID.

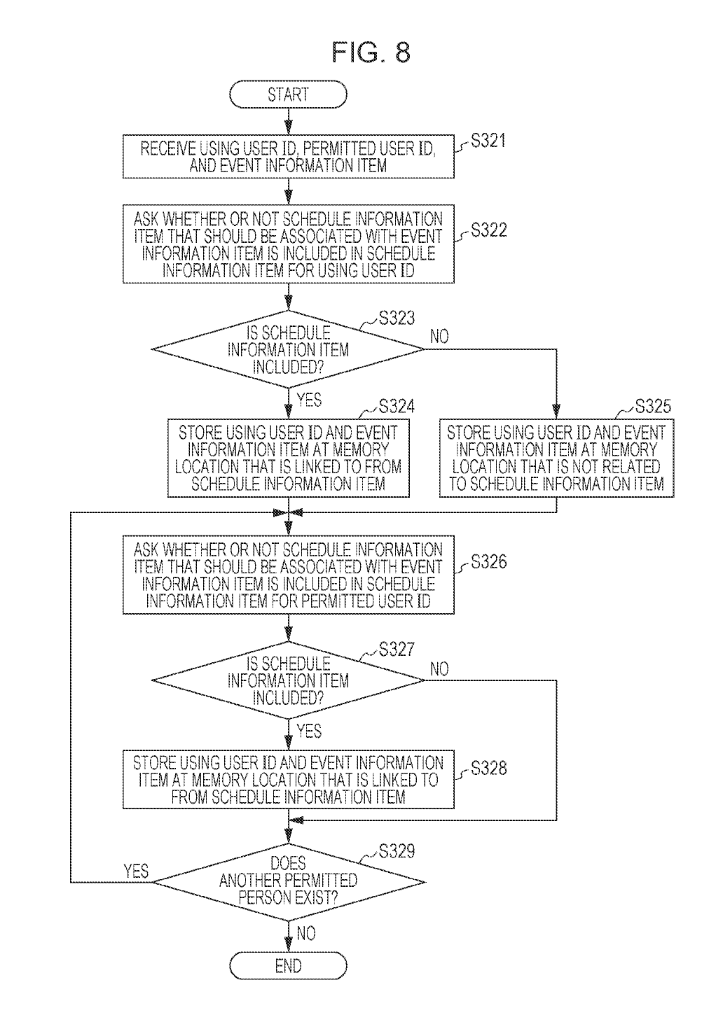

FIG. 8 is a flowchart illustrating an example of the operation that is performed by the document server 30 in the case where the document server 30 stores an event information item.

When the operation starts, in the document server 30, first, the receiving unit 48 receives a using user ID, a permitted user ID, and an event information item from the client terminal 10 (step S321). Note that the using user ID, the permitted user ID, and the event information item that have been received are passed on to the event-information management unit 43.

Then, the event-information management unit 43 passes, to the transmitting unit 42, on an information item asking whether or not a schedule information item that should be associated with the event information item is included in a schedule information item that is the schedule information item of a using user and that is managed by the schedule server 70 (see FIG. 3), and the transmitting unit 42 transmits the information item to the schedule server 70 (step S322). More specifically, an information item asking whether or not a schedule information item associated with a time slot including an event occurrence time included in the event information item is included in the schedule information item associated with the using user ID is transmitted. The reason for this is that it is supposed that, for example, an event that has occurred in the client terminal 10 of the using user during a meeting is to be associated with a portion which is a portion of the schedule of the using user and which is related to the meeting.

Accordingly, when the receiving unit 48 has received a response from the schedule server 70, the event-information management unit 43 determines whether or not the response indicates that a schedule information item which should be associated with the event information item is included (step S323).

As a result, when the event-information management unit 43 determines that the response indicates that a schedule information item which should be associated with the event information item is included, the event-information management unit 43 stores the using user ID and the event information item at a memory location that is a location in the event-information memory 44 and that is linked to from the schedule information item (step S324). More specifically, in the case where a memory location which is linked to from the schedule information item and at which the using user ID and the event information item are to be stored has already been allocated, an information item that specifies the memory location is included in the response from the schedule server 70. Accordingly, the using user ID and the event information item are stored at the memory location specified by the information item. In contrast, in the case where a memory location which is linked to from the schedule information item and at which the using user ID and the event information item are to be stored has not been allocated, a memory location is allocated and linked to from the schedule information item, and the using user ID and the event information item are stored at the memory location.

In contrast, when the event-information management unit 43 determines that the response does not indicate that a schedule information item which should be associated with the event information item is included, the event-information management unit 43 stores the using user ID and the event information item at a memory location that is a location in the event-information memory 44 and that is not related to the schedule information item (step S325).

Moreover, the event-information management unit 43 passes, to the transmitting unit 42, on an information item asking whether or not a schedule information item that should be associated with the event information item is included in a schedule information item that is the schedule information item of a permitted user and that is managed by the schedule server 70 (see FIG. 3), and the transmitting unit 42 transmits the information item to the schedule server 70 (step S326). More specifically, an information item asking whether or not a schedule information item associated with the time slot including the event occurrence time included in the event information item is included in the schedule information item associated with the permitted user ID is transmitted. The reason for this is that it is supposed that, for example, an event that has occurred in the client terminal 10 of the using user during a meeting is to be associated with a portion which is a portion of the schedule of another attendee and which is related to the meeting.

Accordingly, when the receiving unit 48 has received a response from the schedule server 70, the event-information management unit 43 determines whether or not the response indicates that a schedule information item which should be associated with the event information item is included (step S327).

As a result, when the event-information management unit 43 determines that the response indicates that a schedule information item which should be associated with the event information item is included, the event-information management unit 43 stores the using user ID and the event information item at a memory location that is a location in the event-information memory 44 and that is linked to from the schedule information item (step S328). More specifically, in the case where a memory location which is linked to from the schedule information item and at which the using user ID and the event information item are to be stored has already been allocated, an information item that specifies the memory location is included in the response from the schedule server 70. Accordingly, the using user ID and the event information item are stored at the memory location specified by the information item. In contrast, in the case where a memory location which is linked to from the schedule information item and at which the using user ID and the event information item are to be stored has not been allocated, a memory location is allocated and linked to from the schedule information item, and the using user ID and the event information item are stored at the memory location.

In contrast, the event-information management unit 43 determines that the response does not indicate that a schedule information item which should be associated with the event information item is included, because a process of storing the using user ID and the event information item at a memory location that is a location in the event-information memory 44 and that is not related to the schedule information item has already been performed in step S325, here, the event-information management unit 43 does not perform the process of storing the using user ID and the event information item.

After that, the event-information management unit 43 determines whether or not another permitted person exists (step S329). When another permitted person exists, the process returns to step S326. When another permitted person does not exist, the process finishes.

Note that, in the example of the operation, the document server 30 associates a using user ID and an event information item with a schedule information item associated with the using user ID, and, in addition, associates the using user ID and the event information item with a schedule information item associated with a permitted user ID. However, the process of associating a using user ID and an event information item with a schedule information item of a permitted user is not necessarily performed. In the case where the process of associating a using user ID and an event information item with a schedule information item of a permitted user is not performed, all event information items that can be traced from the schedule information item of a using user are event information items concerning events that occurred in the client terminal 10 of the using user. Accordingly, the using user ID of the using user does not need to be stored.

### Description of the Present Exemplary Embodiment Finishes

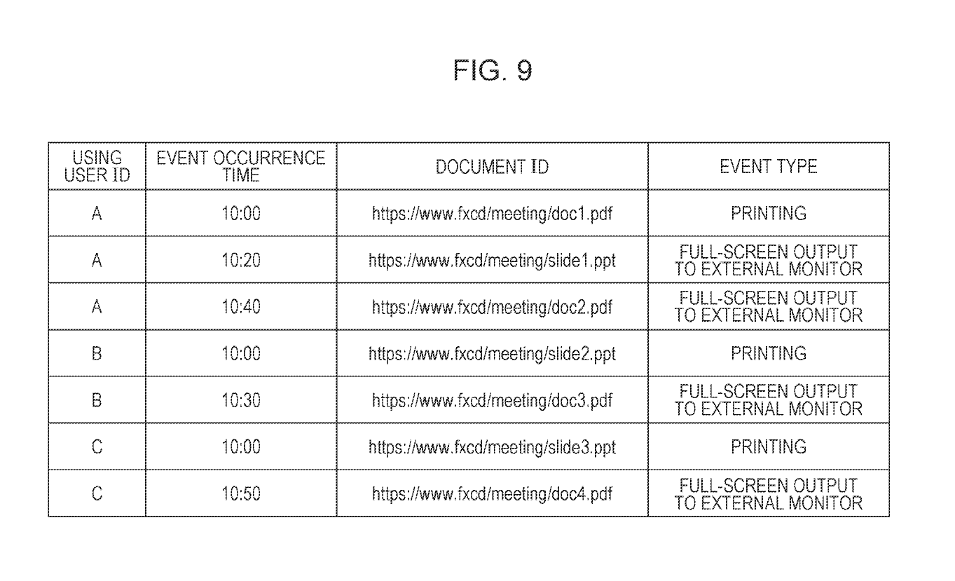

FIG. 9 is a diagram illustrating examples of a using user ID and an event information item that are stored in the event-information memory 44 by performing the above-described process.

As illustrated in FIG. 9, in the event-information memory 44, an event information item including an event occurrence time, a document ID, an event type is stored so as to be associated with a using user ID. Note that, because this example is provided in accordance with the supposed case illustrated in FIG. 3, “A”, “B”, and “C” denoting the users A to C who are attendees to the meeting are registered as using user IDs.

Here, the using user IDs and event information items illustrated in FIG. 9 are stored at all of memory locations that are linked to from schedule information items which are included in the schedule information item of the user A and which concern the meeting, memory locations that are linked to from schedule information items which are included in the schedule information item of the user B and which concern the meeting, and memory locations that are linked to from schedule information items which are included in the schedule information item of the user C and which concern the meeting.

In other words, in step S321 illustrated in FIG. 8, when the using user ID “A”, permitted user IDs “B” and “C”, and the event information items in the first to third rows are received from the client terminal 10a, the using user ID “A” and the event information items are stored at not only memory locations that are linked to from schedule information items which are included in the schedule information item of the user A who is the using user and which concern the meeting, but also memory locations that are linked to from schedule information items which are included in the schedule information items of the users B and C who are permitted users and which concern the meeting.

Furthermore, in step S321 illustrated in FIG. 8, when the using user ID “B”, permitted user IDs “A” and “C”, and the event information items in the fourth and fifth rows are received from the client terminal 10b, the using user ID “B” and the event information items are stored at not only memory locations that are linked to from schedule information items which are included in the schedule information item of the user B who is the using user and which concern the meeting, but also memory locations that are linked to from schedule information items which are included in the schedule information items of the users A and C who are permitted users and which concern the meeting.

Moreover, in step S321 illustrated in FIG. 8, when the using user ID “C”, permitted user IDs “A” and “B”, and the event information items in the sixth and seventh rows are received from the client terminal 10c, the using user ID “C” and the event information items are stored at not only memory locations that are linked to from schedule information items which are included in the schedule information item of the user C who is the using user and which concern the meeting, but also memory locations that are linked to from schedule information items which are included in the schedule information items of the users A and B and which concern the meeting.

As a result, as described above, by utilizing the schedule server 70 from the client terminal 50 that is arbitrarily provided, the individual users view the document files that were used in the meeting. In this case, filtering using an attribute information item such as a date and time, the file type, a file name, or the event type may be performed on the document files.

Note that, as a matter of course, a program which realizes the present exemplary embodiment may be provided by a communication medium. Alternatively, the program may be stored on a recording medium such as a compact disc read-only memory (CD-ROM), and provided.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a detector that detects an event which has occurred in the information processing apparatus;
a first determination unit that determines whether or not a type of event into which the event detected by the detector is classified is included in a plurality of types of events which are determined in advance;
an identification unit that identifies data which is a target for the event detected by the detector;
a second determination unit that determines whether or not a type of data into which the data identified by the identification unit is classified is included in a plurality of types of data that are determined in advance; and
a transmitting unit that, under a condition where it is determined by the first determination unit that the type of event is included in the plurality of types of events and it is determined by the second determination unit that the type of data is included in the plurality of types of data, transmits, to another apparatus, an information item indicating a specific operator who is operating the information processing apparatus, an information item indicating a time at which the event occurred, the data or an information item used to refer to the data, and an information item indicating the details of the event.

2. The information processing apparatus according to claim 1,
wherein the detector detects the event which has occurred in an application program that is operating in the information processing apparatus, and
wherein the identification unit identifies the data indicated by an information item that has been output from the application program when the event has been detected by the detector.

3. The information processing apparatus according to claim 1,
wherein the detector detects the event that outputs, to the outside of the information processing apparatus, contents displayed on a display screen of the information processing apparatus, and
wherein the identification unit identifies the data that corresponds to an image which has been displayed in the display screen when the event has been detected by the detector.

4. The information processing apparatus according to claim 2,
wherein the detector detects the event that outputs, to the outside of the information processing apparatus, contents displayed on a display screen of the information processing apparatus, and
wherein the identification unit identifies the data that corresponds to an image which has been displayed in the display screen when the event has been detected by the detector.

5. An information processing system comprising:
an operation apparatus that is used by a specific operator to perform an operation on data; and
an access apparatus that is able to access a plurality of action-plan information items, each of the plurality of action-plan information items indicating an action plan of a corresponding one of a plurality of operators,
the operation apparatus including
a detector that detects an event which has occurred in the operation apparatus,
a first determination unit that determines whether or not a type of event into which the event detected by the detector is classified is included in a plurality of types of events which are determined in advance,
an identification unit that identifies data which is a target for the event detected by the detector,
a second determination unit that determines whether or not a type of data into which the data identified by the identification unit is classified is included in a plurality of types of data that are determined in advance, and
a transmitting unit that, under a condition where it is determined by the first determination unit that the type of event is included in the plurality of types of events and it is determined by the second determination unit that the type of data is included in the plurality of types of data, transmits, to the access apparatus, an operator information item which indicates the specific operator, and an event information item which includes an information item indicating a time at which the event occurred, the data or an information item used to refer to the data, and an information item indicating the details of the event,
the access apparatus including
a receiving unit that receives the operator information item and the event information item which have been transmitted by the transmitting unit,
a selection unit that selects, from among the plurality of action-plan information items, a specific action-plan information item which indicates an action plan of the specific operator and which is managed so as to be associated with the operator information item received by the receiving unit, and
a storage unit that stores the event information item, which has been received by the receiving unit, so that the event information item is associated with the specific action-plan information item selected by the selection unit.

6. The information processing system according to claim 5,
wherein the transmitting unit further transmits a permitted-person information item indicating a permitted person who is an operator having permission to use the event information item among the plurality of operators,
wherein the receiving unit further receives the permitted-person information item transmitted by the transmitting unit,
wherein the selection unit further selects, among the plurality of action-plan information items, a different action-plan information item that indicates an action plan of the permitted person and that is managed so as to be associated with the permitted-person information item received by the receiving unit, and
wherein the storage unit stores the operator information item and the event information item, which have been received by the receiving unit, so that the operator information item and the event information item are associated with the different action-plan information item selected by the selection unit.

7. An information processing method comprising:
detecting an event which has occurred in an apparatus;
determining whether or not a type of event into which the detected event is classified is included in a plurality of types of events which are determined in advance;
identifying data which is a target for the detected event;
determining whether or not a type of data into which the identified data is classified is included in a plurality of types of data that are determined in advance; and
transmitting, under a condition where it is determined that the type of event is included in the plurality of types of events and it is determined that the type of data is included in the plurality of types of data, to another apparatus, an information item indicating a specific operator who is operating the apparatus, an information item indicating a time at which the event occurred, the data or an information item used to refer to the data, and an information item indicating the details of the event.

8. A non-transitory computer-readable medium storing a program causing a computer to execute a process, the process comprising:
detecting an event which has occurred in an apparatus;
determining whether or not a type of event into which the detected event is classified is included in a plurality of types of events which are determined in advance;
identifying data which is a target for the detected event;
determining whether or not a type of data into which the identified data is classified is included in a plurality of types of data that are determined in advance; and
transmitting, under a condition where it is determined that the type of event is included in the plurality of types of events and it is determined that the type of data is included in the plurality of types of data, to another apparatus, an information item indicating a specific operator who is operating the apparatus, an information item indicating a time at which the event occurred, the data or an information item used to refer to the data, and an information item indicating the details of the event.
